(19) United States
(12) Patent Application Publication
(10) Pub. No.: US 2007/0058538 A1
(43) Pub. Date: Mar. 15, 2007

(54) Method of setting up a wireless router

(76) Inventors: Wei Chiang, Taipei City (TW); Jeng-Da Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/162,574

(22) Filed: Sep. 15, 2005

(51) Int. Cl. H04L 12/26; H04L 12/56

(52) U.S. Cl. 370/230; 370/395.21

(57) ABSTRACT

A method of detecting and configuring an internet connection of a router includes verifying that the router is connected to a physical internet connection, transmitting a Dynamic Host Configuration Protocol (DHCP) request through the physical internet connection, configuring the router to use a DHCP internet connection if a response is received from a DHCP server, transmitting a Point-to-Point Protocol over Ethernet (PPPoE) request through the physical internet connection, configuring the router to use a PPPoE internet connection if a response is received from a PPPoE server, and configuring the router to use a fixed Internet Protocol (IP) address internet connection if a response is not received from either the DHCP server or the PPPoE server.

### BACKGROUND OF THE INVENTION

1. Field of the Invention

The invention relates to a method of configuring a router, and more particularly, to a method for automatically detecting a type of internet connection and configuring a wireless router to work with the internet connection while requiring minimal user input.

2. Description of the Prior Art

The majority of consumers are not familiar with the Dynamic Host Configuration Protocol (DHCP), Point-to-Point Protocol over Ethernet (PPPoE), and fixed Internet Protocol (IP) address internet connection types. Most broadband users are aware that they have a broadband internet connection, but do not know which specific type of internet connection it is. Moreover, they also do not know if the internet connection that they have is a gigabit connection (1 Gbps, 1 billion bits per second), a 100 Mbps (megabits per second) connection, or a 10 Mbps connection. Indeed, some users may not even know if they have a cable modem connection, a digital subscriber line (xDSL) connection, or some other type of internet connection. Usually this lack of knowledge does not present a major problem once all existing networking equipment has been setup. However, when setting up new networking equipment, such as a router or a wireless router, the user may run into problems during the setup process.

Typically, when setting up new networking equipment, the user needs to know information about the type of internet connection used. Questions can be asked during setup to help determine the connection type. These questions help the networking equipment to narrow down the number of possibilities of the various different types of internet connections. Even so, the user is not always able to answer these questions, and must sometimes guess at the answers. Guessing incorrectly may force the user to go through several rounds of trial and error, and choosing the wrong setting can lead to the networking equipment not being setup properly.

### SUMMARY OF THE INVENTION

Methods for detecting a type of internet connection and setting up the internet connection are provided. An exemplary embodiment of a method of detecting and configuring an internet connection of a router includes verifying that the router is connected to a physical internet connection, transmitting a Dynamic Host Configuration Protocol (DHCP) request through the physical internet connection, configuring the router to use a DHCP internet connection if a response is received from a DHCP server, transmitting a Point-to-Point Protocol over Ethernet (PPPoE) request through the physical internet connection, configuring the router to use a PPPoE internet connection if a response is received from a PPPoE server, and configuring the router to use a fixed Internet Protocol (IP) address internet connection if a response is not received from either the DHCP server or the PPPoE server.

Another exemplary embodiment of a method of detecting and configuring an internet connection of a wireless router includes verifying that the wireless router is connected to a physical internet connection, transmitting a DHCP request through the physical internet connection, configuring the wireless router to use a DHCP internet connection if a response is received from a DHCP server, transmitting a PPPoE request through the physical internet connection if no response is received from the DHCP server, configuring the wireless router to use a PPPoE internet connection if a response is received from a PPPoE server, and configuring the wireless router to use a fixed IP address internet connection if a response is not received from either the DHCP server or the PPPoE server.

It is an advantage of the present invention that the user does not need to know anything about the type of internet connection being used, and the router can quickly and automatically detect the type of connection. After the type of connection has been detected, the router can be configured accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating the present invention method of detecting a type of internet connection used and configuring the wireless router to use the detected internet connection.

FIG. 2 is a flowchart illustrating the present invention method of detecting the speed of an internet connection.

### DETAILED DESCRIPTION

For making the process of setting up network equipment as convenient and user-friendly as possible, a method of detecting a type of internet connection is proposed. After the type of internet connection is detected, the networking equipment is configured according to the detected internet connection type. Although a wireless router is used as an example of the networking equipment in the description below, this should not be construed as limiting the applicability of the present invention method to other types of networking equipment.

Before starting the auto configuration process of the wireless router, the user should plug a network cable leading from the internet connection into the wide area network (WAN) port of the wireless router. The internet connection may be a cable modem connection, an xDSL connection, and so on. Next, the user should ensure that a computer used for setting up the wireless router is able to communicate with the wireless router. The computer can either communicate with the wireless router wirelessly or through a network cable connection. Then, the user should open a web browser on the computer and enter a predetermined network address that is used for setting up the wireless router. Some common examples of the network addresses used in industry for setting up routers are http://192.168.0.1, http://192.168.1.1, or http://192.168.2.1. After the user enters this predetermined network address, an installation wizard is started, which will automatically configure the router according to a detected internet connection type.

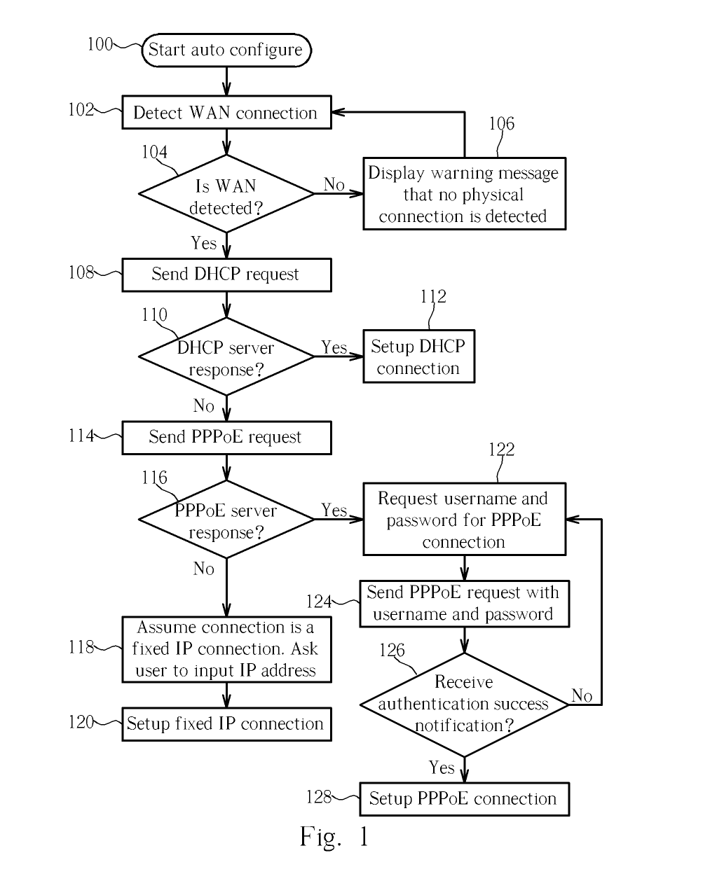

Please refer to FIG. 1. FIG. 1 is a flowchart illustrating the present invention method of detecting a type of internet connection used and configuring the wireless router to use the detected internet connection. Steps contained in the flowchart will be explained below.

Step 100: Start the automatic configuration process.

Step 102: Detect the router's physical connection to a WAN.

Step 104: If the router has a WAN physical connection, go to step 108. If not, go to step 106.

Step 106: Since no WAN physical connection was detected, an error message is displayed telling the user that the network cable should be plugged into the WAN port of the wireless router. The process will then go back to step 102 to keep trying to detect the router's physical connection to a WAN.

Step 108: Since the router is now connected to the internet connection, a DHCP request packet is sent out to determine if the wireless router is connected to a DHCP internet connection.

Step 110: Determine if the router has received a response from a DHCP server. If so, go to step 112. If not, go to step 114.

Step 112: The response from the DHCP server indicates that the wireless router is connected to a DHCP internet connection. Therefore, the router is configured to use DHCP network settings.

Step 114: A PPPoE request packet is sent out to determine if the wireless router is connected to a PPPoE internet connection.

Step 116: Determine if the router has received a response from a PPPoE server. If so, go to step 118. If not, go to step 122.

Step 118: Since the internet connection is neither DHCP nor PPPoE, the internet connection is assumed to be a fixed IP address internet connection. Therefore, the user is prompted to enter the fixed IP address that is assigned to this internet connection.

Step 120: The router is configured to use fixed IP address network settings.

Step 122: The response from the PPPoE server indicates that the wireless router is connected to a PPPoE internet connection. Therefore, the user is prompted to enter the username and password assigned to this internet connection.

Step 124: A PPPoE request containing the username and password is sent to the PPPoE server for authentication.

Step 126: Determine if an authentication success packet is received from the PPPoE server. If so, to go step 128. If not, go back to step 122 to request another username and password.

Step 128: The router is configured to use PPPoE network settings.

Please keep in mind that in the above steps, the order of detecting the DHCP and PPPoE internet connection types can also be reversed.

Each of the DHCP, PPPoE, and fixed IP address types of internet connections can accommodate different data transfer speed settings. Currently most networks have speeds of 10/100 Mbps, which means that data can be transferred at speeds of up to 10 megabits per second or 100 megabits per second. In addition, gigabit Ethernet is also starting to become popular, and allows data transfer speeds of up to 1 Gbps, or one gigabit per second. Therefore, detecting the type of internet connection provided also requires detecting the maximum speed at which data can be sent and received through the internet connection. In order to accomplish this speed detection, different request packets are sent in order to ascertain maximum speed of the internet connection. Besides those mentioned above, other data transfer speeds can also be detected as well.

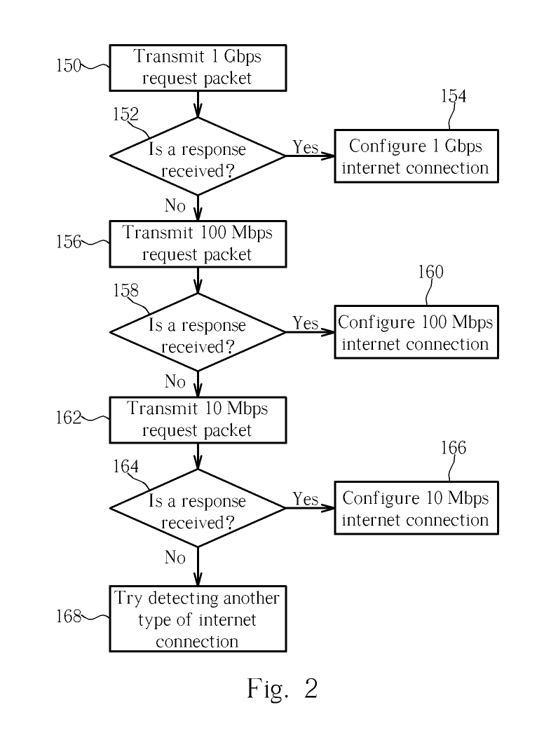

Please refer to FIG. 2. FIG. 2 is a flowchart illustrating the present invention method of detecting the speed of an internet connection. The steps in the flowchart of FIG. 2 can be used to enhance the steps in the flowchart of FIG. 1 so that the type of internet connection and the speed of the internet connection can both be determined in one process. Steps contained in the flowchart will be explained below.

Step 150: Transmit a 1 Gbps request packet to detect if the internet connection supports speeds of up to 1 Gbps.

Step 152: Determine if a response is received acknowledging that the internet connection is capable of supporting speeds of up to 1 Gbps. If a response is received, go to step 154. If not, go to step 156.

Step 154: Configure the wireless router to use 1 Gbps network settings.

Step 156: Transmit a 100 Mbps request packet to detect if the internet connection supports speeds of up to 100 Mbps.

Step 158: Determine if a response is received acknowledging that the internet connection is capable of supporting speeds of up to 100 Mbps. If a response is received, go to step 160. If not, go to step 162.

Step 160: Configure the wireless router to use 100 Mbps network settings.

Step 162: Transmit a 10 Mbps request packet to detect if the internet connection supports speeds of up to 10 Mbps.

Step 164: Determine if a response is received acknowledging that the internet connection is capable of supporting speeds of up to 10 Mbps. If a response is received, go to step 166. If not, go to step 168.

Step 166: Configure the wireless router to use 10 Mbps network settings.

Step 168: Since this type of internet connection does not support any of the three network speeds, it can be concluded that this is not the correct type of internet connection. Instead, the above steps should be repeated for a different internet connection protocol until the correct internet connection protocol and the correct network speed are detected.

Therefore, the above steps are repeated for each type of internet connection until the correct internet connection type and the correct network speed are detected. For detecting the speed of the fixed IP address internet connection, a ping can be transmitted to a predetermined address instead of transmitting a request packet. Furthermore, transmitting the 1 Gbps request packet is optional, and the scope of the present invention also includes transmitting only the 100 Mbps and the 10 Mbps request packets.

In summary, an installation wizard can be designed to incorporate the internet connection detection and configuration steps shown above for setting up network equipment such as a wireless router. Almost all of the steps are performed without any user interaction being required. The user does not need to know anything about the type of internet connection being used, and the router can quickly and automatically detect the type of connection. After the type of connection has been detected, the router can be configured accordingly. The user only needs to know the most basic details about his connection such as his username and password or his fixed IP address in order for configuration to be complete.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of detecting and configuring an internet connection of a router, the method comprising:
verifying that the router is connected to a physical internet connection;
transmitting a Dynamic Host Configuration Protocol (DHCP) request through the physical internet connection;
configuring the router to use a DHCP internet connection if a response is received from a DHCP server;
transmitting a Point-to-Point Protocol over Ethernet (PPPoE) request through the physical internet connection;
configuring the router to use a PPPoE internet connection if a response is received from a PPPoE server; and
configuring the router to use a fixed Internet Protocol (IP) address internet connection if a response is not received from either the DHCP server or the PPPoE server.

2. The method of claim 1, wherein the DHCP request is transmitted before transmitting the PPPoE request, and transmitting the PPPoE request through the physical internet connection is only performed if no response is received from the DHCP server.

3. The method of claim 1, wherein the PPPoE request is transmitted before transmitting the DHCP request, and transmitting the DHCP request through the physical internet connection is only performed if no response is received from the PPPoE server.

4. The method of claim 1, wherein transmitting the DHCP request through the physical internet connection and configuring the router to use the DHCP internet connection if the response is received from a DHCP server comprises:
transmitting a 100 Mbps (megabits per second) request packet;
configuring the router to use a 100 Mbps DHCP internet connection if a response is received from the DHCP server authorizing the 100 Mbps connection;
transmitting a 10 Mbps request packet if no response is received from the DHCP server authorizing the 100 Mbps connection; and
configuring the router to use a 10 Mbps DHCP internet connection if a response is received from the DHCP server authorizing the 10 Mbps connection.

5. The method of claim 1, wherein transmitting the DHCP request through the physical internet connection and configuring the router to use the DHCP internet connection if the response is received from a DHCP server comprises:
transmitting a 1 Gbps (gigabit per second) request packet;
configuring the router to use a 1 Gbps DHCP internet connection if a response is received from the DHCP server authorizing the 1 Gbps connection;
transmitting a 100 Mbps (megabits per second) request packet if no response is received from the DHCP server authorizing the 1 Gbps connection;
configuring the router to use a 100 Mbps DHCP internet connection if a response is received from the DHCP server authorizing the 100 Mbps connection;
transmitting a 10 Mbps request packet if no response is received from the DHCP server authorizing the 100 Mbps connection; and
configuring the router to use a 10 Mbps DHCP internet connection if a response is received from the DHCP server authorizing the 10 Mbps connection.

6. The method of claim 1, wherein transmitting the PPPoE request through the physical internet connection and configuring the router to use the PPPoE internet connection if the response is received from a PPPoE server comprises:
transmitting a 100 Mbps (megabits per second) request packet;
configuring the router to use a 100 Mbps PPPoE internet connection if a response is received from the PPPoE server authorizing the 100 Mbps connection;
transmitting a 10 Mbps request packet if no response is received from the PPPoE server authorizing the 100 Mbps connection; and
configuring the router to use a 10 Mbps PPPoE internet connection if a response is received from the PPPoE server authorizing the 10 Mbps connection.

7. The method of claim 1, wherein transmitting the PPPoE request through the physical internet connection and configuring the router to use the PPPoE internet connection if the response is received from a PPPoE server comprises:
transmitting a 1 Gbps (gigabit per second) request packet;
configuring the router to use a 1 Gbps PPPoE internet connection if a response is received from the PPPoE server authorizing the 1 Gbps connection;
transmitting a 100 Mbps (megabits per second) request packet if no response is received from the PPPoE server authorizing the 1 Gbps connection;
configuring the router to use a 100 Mbps PPPoE internet connection if a response is received from the PPPoE server authorizing the 100 Mbps connection;
transmitting a 10 Mbps request packet if no response is received from the PPPoE server authorizing the 100 Mbps connection; and
configuring the router to use a 10 Mbps PPPoE internet connection if a response is received from the PPPoE server authorizing the 10 Mbps connection.

8. The method of claim 1, wherein configuring the router to use the fixed IP address internet connection comprises:
entering an IP address for the router to use to communicate;
transmitting a first ping to a predetermined address at 100 Mbps (megabits per second);
configuring the router to use a 100 Mbps fixed IP address internet connection if the first ping was successfully received;
transmitting a second ping to the predetermined address at 10 Mbps if the first ping was not successfully received; and
configuring the router to use a 10 Mbps fixed IP address internet connection if the second ping was successfully received.

9. The method of claim 1, wherein configuring the router to use the fixed IP address internet connection comprises:
entering an IP address for the router to use to communicate;
transmitting a first ping to a predetermined address at 1 Gbps (gigabit per second);
configuring the router to use a 1 Gbps fixed IP address internet connection if the first ping was successfully received;
transmitting a second ping to a predetermined address at 100 Mbps (megabits per second) if the first ping was not successfully received;
configuring the router to use a 100 Mbps fixed IP address internet connection if the second ping was successfully received;
transmitting a third ping to the predetermined address at 10 Mbps if the second ping was not successfully received; and
configuring the router to use a 10 Mbps fixed IP address internet connection if the third ping was successfully received.

10. The method of claim 1, wherein configuring the router to use the PPPoE internet connection comprises:
requesting a user to enter a username and password;
transmitting a PPPoE request packet along with the entered username and password;
receiving an authentication response from the PPPoE server authorizing the PPPoE connection; and
finalizing the PPPoE internet connection.

11. The method of claim 1, wherein the router is a wireless router.

12. A method of detecting and configuring an internet connection of a wireless router, the method comprising:
verifying that the wireless router is connected to a physical internet connection;
transmitting a Dynamic Host Configuration Protocol (DHCP) request through the physical internet connection;
configuring the wireless router to use a DHCP internet connection if a response is received from a DHCP server;
transmitting a Point-to-Point Protocol over Ethernet (PPPoE) request through the physical internet connection if no response is received from the DHCP server;
configuring the wireless router to use a PPPoE internet connection if a response is received from a PPPoE server; and
configuring the wireless router to use a fixed Internet Protocol (IP) address internet connection if a response is not received from either the DHCP server or the PPPoE server.

13. The method of claim 12, wherein transmitting the DHCP request through the physical internet connection and configuring the wireless router to use the DHCP internet connection if the response is received from a DHCP server comprises:
transmitting a 100 Mbps (megabits per second) request packet;
configuring the wireless router to use a 100 Mbps DHCP internet connection if a response is received from the DHCP server authorizing the 100 Mbps connection;
transmitting a 10 Mbps request packet if no response is received from the DHCP server authorizing the 100 Mbps connection; and
configuring the wireless router to use a 10 Mbps DHCP internet connection if a response is received from the DHCP server authorizing the 10 Mbps connection.

14. The method of claim 12, wherein transmitting the DHCP request through the physical internet connection and configuring the wireless router to use the DHCP internet connection if the response is received from a DHCP server comprises:
transmitting a 1 Gbps (gigabit per second) request packet;
configuring the wireless router to use a 1 Gbps DHCP internet connection if a response is received from the DHCP server authorizing the 1 Gbps connection;
transmitting a 100 Mbps (megabits per second) request packet if no response is received from the DHCP server authorizing the 1 Gbps connection;
configuring the wireless router to use a 100 Mbps DHCP internet connection if a response is received from the DHCP server authorizing the 100 Mbps connection;
transmitting a 10 Mbps request packet if no response is received from the DHCP server authorizing the 100 Mbps connection; and
configuring the wireless router to use a 10 Mbps DHCP internet connection if a response is received from the DHCP server authorizing the 10 Mbps connection.

15. The method of claim 12, wherein transmitting the PPPoE request through the physical internet connection and configuring the wireless router to use the PPPoE internet connection if the response is received from a PPPoE server comprises:
transmitting a 100 Mbps (megabits per second) request packet;
configuring the wireless router to use a 100 Mbps PPPoE internet connection if a response is received from the PPPoE server authorizing the 100 Mbps connection;
transmitting a 10 Mbps request packet if no response is received from the PPPoE server authorizing the 100 Mbps connection; and
configuring the wireless router to use a 10 Mbps PPPoE internet connection if a response is received from the PPPoE server authorizing the 10 Mbps connection.

16. The method of claim 12, wherein transmitting the PPPoE request through the physical internet connection and configuring the wireless router to use the PPPoE internet connection if the response is received from a PPPoE server comprises:
transmitting a 1 Gbps (gigabit per second) request packet;
configuring the wireless router to use a 1 Gbps PPPoE internet connection if a response is received from the PPPoE server authorizing the 1 Gbps connection;
transmitting a 100 Mbps (megabits per second) request packet if no response is received from the PPPoE server authorizing the 1 Gbps connection;
configuring the wireless router to use a 100 Mbps PPPoE internet connection if a response is received from the PPPoE server authorizing the 100 Mbps connection;
transmitting a 10 Mbps request packet if no response is received from the PPPoE server authorizing the 100 Mbps connection; and
configuring the wireless router to use a 10 Mbps PPPoE internet connection if a response is received from the PPPoE server authorizing the 10 Mbps connection.

17. The method of claim 12, wherein configuring the wireless router to use the fixed IP address internet connection comprises:
entering an IP address for the wireless router to use to communicate;
transmitting a first ping to a predetermined address at 100 Mbps (megabits per second);
configuring the wireless router to use a 100 Mbps fixed IP address internet connection if the first ping was successfully received;
transmitting a second ping to the predetermined address at 10 Mbps if the first ping was not successfully received; and
configuring the wireless router to use a 10 Mbps fixed IP address internet connection if the second ping was successfully received.

18. The method of claim 12, wherein configuring the wireless router to use the fixed IP address internet connection comprises:
entering an IP address for the wireless router to use to communicate;
transmitting a first ping to a predetermined address at 1 Gbps (gigabit per second);
configuring the wireless router to use a 1 Gbps fixed IP address internet connection if the first ping was successfully received;
transmitting a second ping to a predetermined address at 100 Mbps (megabits per second) if the first ping was not successfully received;
configuring the wireless router to use a 100 Mbps fixed IP address internet connection if the second ping was successfully received;
transmitting a third ping to the predetermined address at 10 Mbps if the second ping was not successfully received; and
configuring the wireless router to use a 10 Mbps fixed IP address internet connection if the third ping was successfully received.

19. The method of claim 12, wherein configuring the wireless router to use the PPPoE internet connection comprises:
requesting a user to enter a username and password;
transmitting a PPPoE request packet along with the entered username and password;
receiving an authentication response from the PPPoE server authorizing the PPPoE connection; and
finalizing the PPPoE internet connection.
